(19) United States
(12) Patent Application Publication
(10) Pub. No.: US 2026/0321016 A1
(43) Pub. Date: Oct. 15, 2026

(54) VISION CHECKOUT INTERVENTION SUPPRESSION

(71) Applicant: NCR Voyix Corporation, Atlanta, GA (US)

(72) Inventors: Kip Oliver Morgan, Atlanta, GA (US); Gina Torcivia Bennett, Lawrenceville, GA (US); Alexey Uzintsev, Atlanta, GA (US); Levino Felix Perrucci, Jackson, GA (US)

(21) Appl. No.: 19/643,039

(22) Filed: Apr. 9, 2026

Related U.S. Application Data
(60) Provisional application No. 63/786,274, filed on Apr. 9, 2025.

(51) Int. Cl. G06V 20/52; G06V 10/94; G06V 10/98; G06V 40/10; H04N 23/90; G06Q 20/20

(52) U.S. Cl. CPC G06V 20/52; G06V 10/95; G06V 10/987; G06V 40/10; H04N 23/90; G06Q 20/208

(57) ABSTRACT

Methods, apparatuses, and systems for vision checkout intervention suppression are disclosed. A light-emitting apparatus is provided that detects the presence of an object such as a consumer’s hand in a scan area of a vision-based self-service terminal (SST) and sends a signal to the SST indicative of the detected object, thereby causing an intervention that would otherwise have been triggered based on the object’s presence to be suppressed. In this manner, legitimate actions by a user that involve placing their hand over the scan area and within a field-of-view of a camera of the vision system (e.g., interacting with a touch display of the SST, placing or moving items on a scan plate of the SST, etc.) do not trigger an intervention and do not lead to undesirable outcomes such as an item that was previously recognized and added to the transaction becoming unrecognized and potentially voided.

### BACKGROUND

Consumers utilize self-checkout terminals for a variety of reasons, including to improve transaction efficiency by avoiding potentially long lines at cashier-assisted lanes, to mitigate the risk of disease transmission, or the like. During a self-checkout transaction, consumers are typically required to scan barcoded items to add them to the transaction record, or in the case of non-barcoded items, to enter a product lookup code (PLU) for the item (if known) or select the item from a searchable list of items.

Vision-based self-checkout is a form of self-checkout in which cameras capture images of items placed at a self-service terminal and item recognition is performed based on an analysis of the images, ideally without requiring a consumer to scan barcodes or otherwise provide input that identifies the items. Vision-based self-checkout systems may employ machine learning algorithms that are trained on a training dataset of item images. During a vision-based self-checkout transaction, the captured item images may be provided as input to a trained machine learning algorithm, which may then output identifiers (e.g., PLUs) for the items depicted in the images along with confidence values indicating the likelihood that the item identifiers accurately reflect the depicted items.

While vision-based self-checkout can reduce the manual effort that a consumer typically exerts in conjunction with a self-checkout transaction, it can also result in interventions that introduce friction to the checkout process. For example, if the vision system is not able to identify an item with suitable confidence, it may generate an error message requiring the consumer to identify the item, either through a barcode scan or by providing input to a touch display of the self-checkout terminal. In addition, if an object (e.g., a consumer’s hand) obstructs a camera’s view of an item, the vision system may throw an intervention that instructs the consumer to remove the obstructing object from the scan area so that the vision system can proceed with item identification.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a diagram of a networked architecture for vision checkout intervention suppression according to an embodiment of the present disclosure.

FIG. 2 is a flowchart depicting a method for vision checkout intervention suppression according to an embodiment of the present disclosure.

FIG. 3 is a diagram of a transaction terminal for vision-based item identification and vision checkout intervention suppression according to an embodiment of the present disclosure.

FIG. 4 is a block diagram of a computing system for use with vision-based self-checkout systems according to embodiments of the present disclosure.

### DETAILED DESCRIPTION

In a typical computer vision-based self-checkout scenario, a consumer places items on a surface of a self-service terminal (SST) (e.g., a scan plate/scan area of the SST), cameras positioned around the SST capture images of the items, and a machine learning algorithm (e.g., an item recognition algorithm) identifies the items from the captured images. There are a variety of scenarios in which the vision algorithm may not be able to identify an item with a suitable confidence. For example, if the vision algorithm has not been suitably trained to recognize a given item, the vision-based self-checkout system may trigger an intervention indicating that the item is unrecognized, in which case, the consumer would need to scan a barcode on the item (if present) or otherwise provide input to the SST that identifies the item, such as searching for and selecting the item from a set of candidate items. In another example scenario, if an item is occluded by an object such as another item, the cameras may not be able to capture images of the item that are suitable for item recognition. In such a scenario, the vision-based self-checkout system may similarly trigger an intervention that indicates to the consumer that an item was obstructed from view and that instructs the consumer to remove the occluding object.

In various use case scenarios, the vision-based self-checkout system may trigger an intervention if an unknown object is detected, regardless of whether the object is occluding an item from a camera’s view. For instance, if a consumer’s hand, arm, sleeve, or the like (hereinafter referred to simply as “hand” for ease of reference) is in the cameras’ fields-of-view, the vision algorithm may not be able to identify the hand and may trigger an intervention indicating than an unknown object was detected and instructing the consumer to remove the object (e.g., remove the hand). According to example embodiments of the technology disclosed herein, various cameras of the vision-based self-checkout system sit above a touch display of an SST - supported by a structure that is designed to retrofit to an existing SST. As such, the vision-based system is more likely to detect a consumer’s hand as an unknown object/item while the consumer interacts with the touch display during a transaction as compared to a system in which the cameras are positioned to the side of a scan area and below the touch display.

Because the vision-based self-checkout system is continually monitoring the scan area of the SST for items placed therein, and because the consumer is often moving their hand into the scan area to place or adjust the positioning of items, to interact with a touch display of the SST, or the like, the system may trigger repeated hand error interventions, which can lead to consumer frustration with the self-checkout experience. In addition, when a consumer’s hand is within the field-of-view of a camera, and thus, detected by the vision algorithm, items that were previously recognized by the algorithm can become unrecognized and/or items added to the transaction can become voided (e.g., if obstructed by the hand).

The computer vision algorithm may be trained to recognize hands. However, the accuracy of hand recognition is limited by a number of factors, including the high degree of variation in the appearance of human hands, the variation in objects that may be worn on the hand or wrist, bias that may be present in the training dataset, and so forth. Accordingly, a persistent technical problem with existing vision-based self-checkout systems is that the level of accuracy in hand detection that would be needed to substantially reduce the number of hand error interventions that are triggered is likely not achievable through training of the vision algorithm alone.

Embodiments of the technology disclosed herein include methods, apparatuses, and systems for vision checkout intervention suppression that provide a technical solution to the above-described technical problem of excessive hand error interventions that occur in vision-based self-checkout systems. According to example embodiments of the disclosed technology, a light-emitting apparatus is provided that detects the presence of an object such as a consumer’s hand in a scan area of a vision-based SST and sends a signal to the SST indicative of the detected object, thereby causing an intervention that would otherwise have been triggered based on the object’s presence to be suppressed. In this manner, legitimate actions by a user (user and consumer are used interchangeably herein) that involve placing their hand over the scan area and within a field-of-view of a camera of the vision system (e.g., interacting with a touch display of the SST, placing or moving items on a scan plate of the SST, etc.) do not trigger an intervention and do not lead to undesirable outcomes such as an item that was previously recognized and added to the transaction becoming unrecognized and potentially voided.

In example embodiments of the disclosed technology, the light-emitting apparatus/sensor is a light curtain, strip, or the like (hereinafter just “light sensor” for ease of reference) that is affixed to a scan plate of an SST. For instance, the light sensor may be affixed to or otherwise provided at a front edge of the scan plate. The light sensor may emit a light field perpendicularly from the scan plate. The light sensor is positioned such that an object (e.g., a consumer’s hand) that is extended over the scan plate will disrupt the emitted light field. The light sensor detects the object’s presence based on the disruption of the emitted light field and sends a signal that causes interventions to be suppressed until the object (e.g., hand) is removed and the light field is no longer disrupted. The SST can be informed that the object is no longer within the light field either by no longer receiving the signal from the light sensor or through receipt of another signal from the light sensor that indicates that the object is no longer being detected by the light sensor.

As such, according to embodiments of the disclosed technology, as long as the light sensor detects an object (e.g., a consumer’s hand), all computer vision interventions are suppressed, and the consumer is able to provide input to the touch display of the SST, place and move items on the scan plate, and the like, without being interrupted by undesirable interventions. Once the light sensor no longer detects an item in the emitted light field, the monitoring of the scan area and the item recognition performed by the vision algorithm are once again communicated to components of the SST to enable the items to be added to the transaction. In this manner, the vision algorithm’s item recognition as well as standard interventions due to, for example, unknown items that the algorithm has not been suitably trained on, are unaffected.

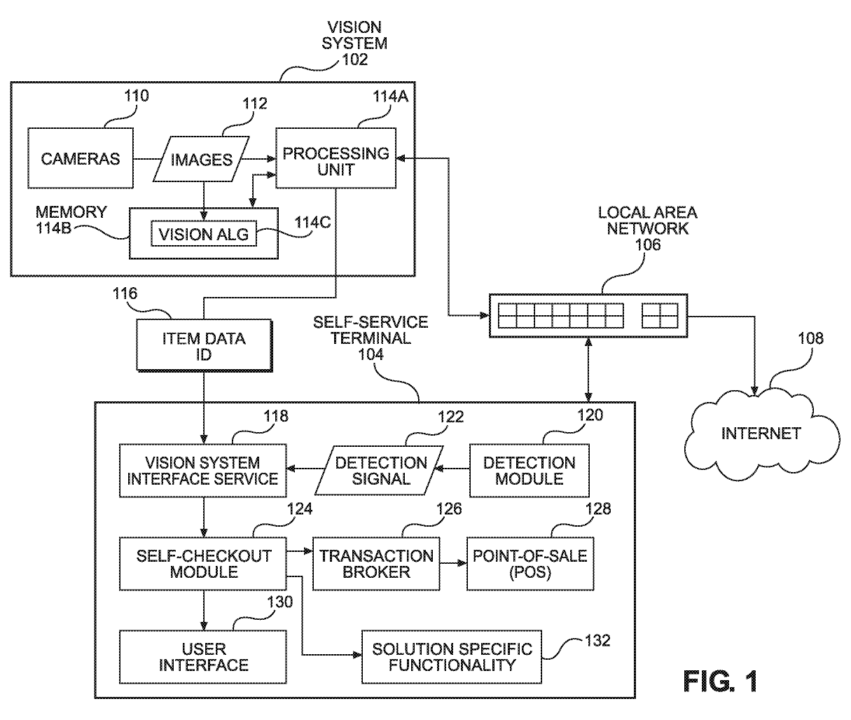

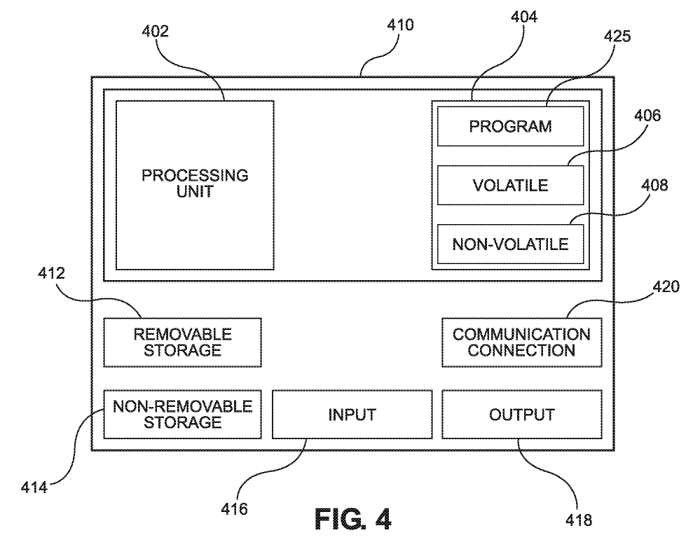

In the present disclosure, like reference numbers refer to like elements throughout the drawings, which illustrate various exemplary embodiments of the present disclosure. Referring now to FIG. 1, a networked architecture for vision checkout intervention suppression according to an embodiment of the present disclosure is shown. The networked architecture includes a computer vision system 102 that, in turn, incudes a set of cameras 110, a processing unit 114A, a memory 114B, and a vision algorithm 114C executable by the processing unit 114A. The processing unit 114A and the memory 114B may form part of a computing device such as the example computing device depicted in FIG. 4.

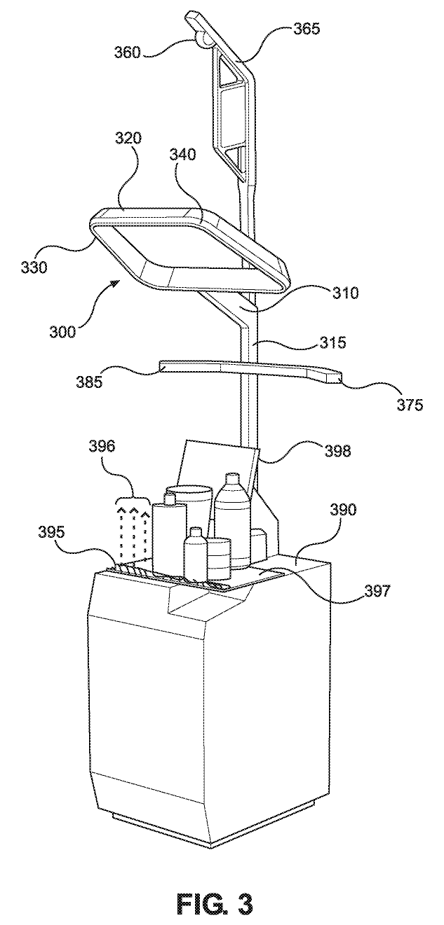

The cameras 110 may be mounted at various positions on a support structure such as that depicted in FIG. 3. The cameras 110 may be mounted above a scan plate/scan area of an SST 104. The cameras 110 monitor a scan plate/scan area of the SST 104 and capture images 112 of items placed thereon. The images 112 are provided as input to the vision algorithm 114C which has been trained to perform item recognition. The vision algorithm 114C outputs item identification data 116 that includes item identifiers for items recognized by the vision algorithm 114C in the images 112 along with, for example, associated confidence values indicative of a likelihood that that the items were accurately recognized.

The vision system 102 may be communicatively coupled to the SST 104 via a local area network 106. For example, the vision system 102 and the SST 104 may be provided within a retail store environment and may communicate with each other via the local area network 106. The local area network 106 may, in turn, be connected to the Internet 108. In some embodiments, the vision algorithm 114C may execute remotely from a store environment in which other components of the vision system 102 (e.g., the cameras 110), the SST 104, and the local area network 106 are provided. In such embodiments, the images 112 may be sent to a remote server, for example, via the local area network’s 106 connection to the Internet 108, and the vision algorithm 114C executing on the remote server may perform item recognition based on the received images 112.

The SST 104 includes a vision system interface service 118 that receives the item identification data 116 from the vision system 102 and sends it to a self-checkout module 124. In example embodiments, the self-checkout module 124 is a software development kit (SDK) that includes libraries, application programming interfaces (APIs), and the like for providing various self-checkout functionality. Solution specific functionality (SSF) 132 may include customizations made to the self-checkout module 124 for a particular retailer, retail environment, SST, or the like. A user interface (UI) 130 is provided (which may be part of the self-checkout module 124). The UI 130 may be presented on a touch display (not shown) of the SST 104. A consumer may interact with the UI 130 to search for items, make selections, complete payments, and the like.

In example embodiments, upon receipt of the item identification data 116 from the vision system interface service 118, the self-checkout module 124 may provide the data 116 to a transaction broker 126. The transaction broker 126 may use the item identifiers in the data 116 to perform a lookup of corresponding pricing information, which it may then provide to a point-of-sale (POS) 128 for addition of the items and corresponding prices to a transaction record. Alternatively, the self-checkout module 124 may look up the pricing information and provide it to the transaction broker 126.

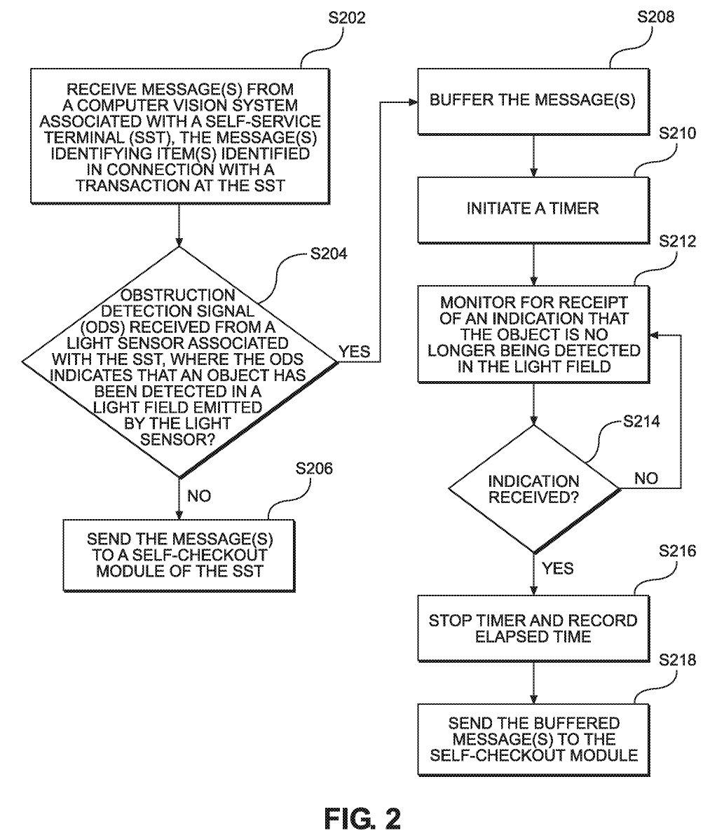

The SST 104 further includes a detection module 120. The detection module 120 may include a light sensor that emits light (e.g., a light field) and associated software logic that generates a detection signal 122 when the light sensor detects an object such as a consumer’s hand within the emitted light field. Operation of the detection module 120 in conjunction with the vision system interface service 118 to suppress interventions will now be described in more detail through reference to FIG. 2.

FIG. 2 is a flowchart depicting a method 200 for vision checkout intervention suppression according to an embodiment of the present disclosure. Referring now to FIG. 2 with reference to FIG. 1, at step S202, the vision system interface service 118 may receive message(s) from the computer vision system 102. The message(s) include the item identification data 116 that includes item identifiers of items recognized by the vision system 102 in connection with a transaction at the SST 104.

At step S204, the vision system interface service 118 determines whether an obstruction detection signal 122 has been received from the detection module 120. In example embodiments, the detection module 120 includes a light sensor that emits a light field and software logic that generates the detection signal 122 when the light sensor detects an object present in the light field. The light sensor may be provided at a front edge of a scan plate of the SST 104 such that placement of a hand over the scan plate to, for example, interact with a touch display of the SST 104 or place/move items on the scan plate causes a disruption to the light field that is detectable by the light sensor and that causes the detection signal 122 to be generated and sent to the vision system interface service 118.

In response to a negative determination at S204, the method 200 proceeds to step S206, where the vision system interface service 118 sends the received message(s) to the self-checkout module 124. That is, if no detection signal 122 is received, this indicates that no object is present in the light field emitted by the light sensor, and thus, the self-checkout module 124 can proceed with facilitating addition of items recognized by the vision system 102 to the transaction. Further, in this scenario, standard interventions (e.g., interventions that don’t result from a user’s hand being present in the scan area) continue to be permitted.

On the other hand, in response to a positive determination at S204, meaning that the detection signal 122 is received, the vision system interface service 118 buffers the message(s) received from the vision system 102 at S208 such that the message(s) are queued and not sent to the self-checkout module 124 until the detection signal 122 is no longer received. Then, at step S210, a timer is initiated. At step S212, the vision system interface service 118 monitors for receipt of an indication that the object is no longer being detected in the light field. At step S214, the service 118 determines whether the indication has been received. As long as the indication has not been received, the method 200 continues to monitor for receipt of the indication at S212. The indication may take the form of cessation of receipt of the detection signal 122, or alternatively, receipt of another signal that indicates that the light sensor is no longer detecting an object (e.g., a hand) obstructing/disrupting the light field.

In response to a positive determination at step S214, the timer is stopped and the elapsed time is recorded at step S216. Then, at step S218, the vision system interface service 118 sends the previously buffered message(s) to the self-checkout module 124 to enable the items recognized by the vision system 102 to be added to the transaction. In some embodiments, the number of instances that an object is detected in the light field may also be tracked.

The method 200, and in particular, the buffering of message(s) received from the vision system 102 while the detection signal 122 is received indicating that an object is being detected by the light sensor within the light field (e.g., a hand is over the scan plate) gives the user the perception that the vision system 102 is not performing item recognition while their hand is disrupting the light field (e.g., while they are interacting with the touch display of the SST 104). In reality, however, the item recognition messages from the vision system 102 are being buffered until the user’s hand is no longer obstructing the light field (no longer in the scan area). Suppressing the triggering of interventions while hands are in the light field enables a user to perform other desirable interactions with the SST 104 without being interrupted by such interventions, thereby enabling a more frictionless self-checkout experience. At the same time, by ensuring that the messages from the vision system 102 are processed when the light field is no longer obstructed, the vision system 102 (which is external to the SST 104) can continue to perform item recognition and trigger standard interventions as needed.

In example embodiments, as noted in the description of the method 200, the time that hands are within (i.e., obstructing/disrupting) the light field is tracked, and optionally, the number of instances of hand interference is tracked as well. Reports can be generated that illustrate how often and how much time hand interference affected a transaction as well as where in the transaction the hand interference occurred. This data can be used to identify friction points to enhance software, instructions, and signage to improve the user’s experience and increase transaction throughput.

For example, if it is determined that hands are in the way frequently during item recognition, a clearer alert to move hands aside can be displayed. Because the user may be intentionally interacting with a touch display of the SST 104, rather than inform the user of the hand interference through the display, in some embodiments, a color of a status pole of the SST 104 can be changed to a uniquely identifiable color that indicates to an attendant a possible problem at the lane. Other status messages/videos can also be displayed at the status pole. In addition, a message may be sent to an attendant’s device indicating that hand interference is occurring.

FIG. 3 is a diagram of a transaction terminal for vision-based item identification and vision checkout intervention suppression according to an embodiment of the present disclosure. Referring now to FIG. 3, in an embodiment, the vision system 102 of FIG. 1 may include a camera support assembly 300 that includes a frame 320 mounted to an arm member 310, which in turn is coupled to a vertical member 315. Two arm extension members 375, 385 may extend outwards from vertical member 315 below frame 320 (in some cases only one of the two arm extension members may be provided). Arm member 310 and vertical member 315 form a bracket for supporting frame 320 and arm extension members 375, 385. The frame 320 is depicted as having a trapezoidal cross-sectional shape, with the side closest to arm member 310 longer than the opposite side (i.e., the two bases of the trapezoid). However, the frame 320 may have other cross-sectional shapes such as a rectangle, an oval, a circle, etc. While the space within frame 320 is open in the depicted embodiment, in other embodiments, a cross member may be provided between opposing sides of the frame 320.

A first camera 340 is mounted to the frame 320 proximal to one corner of the frame 320 on a side of the frame 320 opposite to arm member 310. A second camera 360 is mounted close to the top of a status pole 365, which may have additional functions as part of an associated self-service checkout terminal 390 (e.g., SST 104). A third camera 370 is mounted on a lower portion of the arm 375 at an end thereof distal from vertical member 315 and a fourth camera 380 is mounted on a lower portion of the arm 385 at an end thereof distal from vertical member 315. A lighting strip 330 formed from, e.g., LEDs, may be provided on the lower (underside) edge of a periphery of the frame 320 and may function to illuminate a scan plate 397 to enable better item recognition.

The height of the assembly 300 may be adjustable with respect to pole 365 so that the cameras 340, 370, 380 and the light strip 330 can be directed downward onto a scan area surface (e.g., scan plate 397) of the self-service checkout terminal 390 where merchandise or other items can be placed for item recognition. The cameras 340, 360, 370, 380 are mounted in a downward facing position, with each angled so as to obtain an optimal view of all of the items on the scan plate 397. In further embodiments, additional cameras can be mounted at different locations along the periphery of the frame 320 in order to provide additional views of the scan plate 397. The pole 365 may be a trilight pole that includes a display configured to display various transaction-related information, for example.

FIG. 3 further depicts an example light sensor 395 (e.g., light curtain/strip) provided at a front edge of the scan plate 397. The light sensor 395 is configured to emit light 396 (e.g., a light field). In example embodiments, the light sensor 395 emits the light field 396 at a perpendicular angle from the surface of the scan plate 397. As such, when a hand or other object hovers over the scan plate 397, such as when a user is interacting with a touch display 398 of the self-service checkout terminal 390, the light field 396 is obstructed/disrupted, and the light sensor 395 detects this and causes a detection signal to be generated that results in buffering of messages received from the vision system 102 and suppression of hand interventions until the light field 396 is no longer obstructed/disrupted.

FIG. 4 is a block diagram of a computing device according to an example embodiment for use in implementing the self-service checkout terminal and/or the vision system. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410. and other input devices. The computer 410 may operate in a networked environment using a communication connection 420 to connect to one or more remote computers, such as database servers, web servers, and other computing devices. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method for suppressing vision-based self-checkout interventions, the method comprising:
receiving, at a self-checkout terminal, messages from a computer vision system, the messages identifying items recognized by the computer vision system in connection with a transaction at the self-checkout terminal;
receiving, at the self-checkout terminal, an obstruction detection signal from a light sensor associated with the self-checkout terminal, wherein the obstruction detection signal indicates that an object has been detected by the light sensor;
buffering the messages received from the computer vision system while the obstruction detection signal is received;
monitoring for receipt of an indication that the object is no longer being detected by the light sensor; and
releasing the buffered messages to enable the recognized items to be added to the transaction responsive to receiving the indication that the object is no longer being detected by the light sensor.

2. The method of claim 1, further comprising detecting, by the light sensor, the presence of the object based on disruption, by the object, of a light field emitted by the light sensor.

3. The method of claim 2, wherein the light sensor is provided in proximity to a front edge of a scan plate of the self-checkout terminal and the light field is emitted in a direction that is substantially perpendicular to the scan plate.

4. The method of claim 3, wherein the object is an arm of a user of the self-checkout terminal that when extended over the scan plate causes the light field emitted by the light sensor to be disrupted.

5. The method of claim 1, wherein the indication that the object is no longer being detected by the light sensor comprises cessation of receipt of the obstruction detection signal.

6. The method of claim 1, wherein the computer vision system continues to perform item recognition while the obstruction detection signal is received.

7. The method of claim 1, wherein the triggering of interventions by the computer vision system is suppressed while the obstruction detection signal is received.

8. The method of claim 1, wherein an intervention due to an item not being recognized by the computer vision system is suppressed while the obstruction detection signal is received and is triggered responsive to cessation of receipt of the obstruction detection signal.

9. The method of claim 1, further comprising:
initiating a timer responsive to receipt of the obstruction detection signal;
stopping the timer responsive to receipt of the indication that the object is no longer being detected by the light sensor; and
recording the elapsed time.

10. The method of claim 1, further comprising:
tracking a cumulative elapsed time that the obstruction detection signal is received;
determining that the cumulative elapsed time exceeds a threshold; and
outputting, at the self-checkout terminal, an indication of interference of the object.

11. The method of claim 10, wherein the object is at least a portion of an arm of a user of the self-checkout terminal, and the indication of interference of the object is an alert informing the user to move the at least a portion of the arm away from a scan plate of the self-checkout terminal.

12. The method of claim 10, wherein the indication of interference of the object is a status indicator displayed at the self-checkout terminal.

13. The method of claim 10, wherein the indication of interference of the object is a message sent to a device of an attendant.

14. A self-checkout system configured to suppress vision-based self-checkout interventions, comprising:
a computer vision system comprising a set of cameras and a vision algorithm;
a light sensor; and
a self-checkout terminal communicatively coupled to the computer vision system, the self-checkout terminal comprising:
a processing unit; and
a memory storing computer-executable instructions that when executed by the processing unit cause operations to be performed comprising:
receiving messages from the computer vision system, the messages identifying items recognized by the computer vision system in connection with a transaction at the self-checkout terminal;
receiving an obstruction detection signal from the light sensor, wherein the obstruction detection signal indicates that an object has been detected by the light sensor;
buffering the messages received from the computer vision system while the obstruction detection signal is received;
monitoring for receipt of an indication that the object is no longer being detected by the light sensor; and
releasing the buffered messages to enable the recognized items to be added to the transaction responsive to receiving the indication that the object is no longer being detected by the light sensor.

15. The self-checkout system of claim 14, wherein the light sensor is provided in proximity to a front edge of a scan plate of the self-checkout terminal, and wherein the light sensor detects the presence of the object based on disruption, by the object, of a light field emitted by the light sensor in a direction that is substantially perpendicular from the scan plate.

16. The self-checkout system of claim 15, wherein the object is an arm of a user of the self-checkout terminal that when extended over the scan plate causes the light field emitted by the light sensor to be disrupted.

17. The self-checkout system of claim 14, wherein the indication that the object is no longer being detected by the light sensor comprises cessation of receipt of the obstruction detection signal.

18. The self-checkout system of claim 14, wherein the computer vision system continues to perform item recognition while the obstruction detection signal is received, and wherein the triggering of interventions by the computer vision system are suppressed while the obstruction detection signal is received.

19. The self-checkout system of claim 14, the operations further comprising:
tracking a cumulative elapsed time that the obstruction detection signal is received;
determining that the cumulative elapsed time exceeds a threshold; and
outputting, at the self-checkout terminal, an indication of interference of the object.

20. The self-checkout system of claim 19, wherein the indication of interference of the object is at least one of: an alert informing the user to move at least a portion of the arm away from a scan plate of the self-checkout terminal, a status indicator displayed at the self-checkout terminal, or a message sent to a device of an attendant.
